(19) United States
(12) Patent Application Publication
(10) Pub. No.: US 2008/0158191 A1
(43) Pub. Date: Jul. 3, 2008

(54) Method for zooming image

(75) Inventors: Guan-Li Yang, Nanking (CN); Xiao-Guang Hu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/987,442

(22) Filed: Nov. 30, 2007

(30) Foreign Application Priority Data
Dec. 29, 2006 (TW) 095149804

(51) Int. Cl. G06F 3/041

(52) U.S. Cl. 345/173

(57) ABSTRACT

The present invention discloses a method for zooming image, and the method is implemented to an electronic device having a touch panel. When the touch panel of the electronic device detects that touch points on the touch panel are pressed simultaneously, and one of touch points is moved thereon, then the electronic device will determine whether to zoom in or out an image displayed on the electronic device according to the moving direction of the touch point, and determine to zoom in or out the image in a proportion according to the moving distance of the touch point. Thus, the image displayed on the electronic device can be zoomed in/out by the operation of touch points at the touch panel.

### FIELD OF THE INVENTION

The invention relates to a method for zooming image, and more particularly to a method for zooming an image displayed on a touch panel of an electronic device by operating any two touch points generated on the touch panel.

### BACKGROUND OF THE INVENTION

In a technologically advanced world where the electronic industries thrives, a variety of high-tech and mobile communication products related to computing machines are constantly introduced, and such products are intimately related to people's daily lives as they reduce the spatial and temporal distance between people. As the electronic communication products (such as cell phones and PDA) become more and more popularized and are constantly replaced by newer products, the competition between the makers of such products for greater market shares only grows more intense. The makers achieve this goal by attracting the support of users with more novel and ingenuous products. With increasing demand for quality in the electronic communication products, the presence of electronic communication products that provide more convenient and efficient services has become one of the important criteria for determining if the technology of a country is ahead of other countries.

With the arrival of the 3G technology, many of the applications related to the Internet can be transferred to the new generation of electronic communication products. As a result, the future generation of electronic communication products will serve as the terminal for displaying a variety of multimedia contents, and thus the mobile media browser will undoubtedly become one of the most important applications for the aforesaid terminal, as it is the essential application for browsing the Internet. The mobile media browser is installed on the cell phones and used to display specific applications via the browser of a client, which in turn achieves the following effects:
1. Allowing users to visit any major websites and browse information on any web pages on the Internet;
2. Allowing users to freely browse and download any files such as images and video clips from the Internet; and
3. Allowing users to locate desired information via the search application of the mobile media browser at anytime and anywhere.

When the electronic communication products display the downloaded images or web pages via the mobile media browser; if the images or web pages are larger than that of the touch panel of such electronic communication products, the touch panel cannot comprehensively display the images or web pages, and users must rely on control components (such as touch pens, buttons, or menus) to activate a menu provided by the electronic communication products for enlarging or shrinking the images, click on buttons to zoom in/out the image, or rely on a touch pen to scroll up/down the scroll bar to get the full view of the images. Consequently, it poses great disadvantages and inconvenience to users, especially under certain circumstances (for example, when users are on the phone or driving). Therefore, it is urgent for the industry to come up with a method for zooming image that solves the aforesaid problems.

### SUMMARY OF THE INVENTION

In light of the aforesaid problems, a method for zooming image has been proposed in order to allow users to readily zoom images displayed on the touch panel and facilitate the process for zooming images. The method allows the electronic device to zoom images by operating any two touch points generated on the touch panel.

A primary objective of the invention is to propose a method for zooming image to be implemented to an electronic device having a touch panel. The electronic device may display an image on the touch panel, and the touch panel may detect whether a first touch point and a second touch point on the touch panel are pressed by a user. When the electronic device detects that the first touch point and the second touch point are pressed by the user simultaneously, and the first touch point remains stationary while the second touch point is moving on the touch panel; the electronic device determines whether to zoom in or out the image according to the moving direction of the second touch point operated by the user, and also determines the proportion of zooming in or out the image according to the moving distance of the second touch point operated by the user.

Another objective of the invention is to propose a method for zooming image to be implemented to an electronic device having a touch panel. When the touch panel detects that more than two touch points on the touch panel are clicked simultaneously, the electronic device displays an image shown on the touch panel with a maximum resolution in compliance with the touch panel.

A further objective of the invention is to propose a method for zooming image to be implemented to an electronic device having a touch panel. When the touch panel detects that more than three touch points on the touch panel are pressed simultaneously, the electronic device displays an image shown on the touch panel with its original size on the touch panel.

### BRIEF DESCRIPTION OF THE DRAWINGS

The structure and the technical means adopted by the present invention to achieve the above and other objectives can be best understood by referring to the following detailed description of the preferred embodiments and the accompanying diagrams, wherein:

FIG. 1 is a schematic view that shows the architecture of the invention;

FIG. 2 is a schematic view that shows the operation mode of a preferred embodiment of the invention;

FIG. 3 is a schematic view that shows another operation mode of the preferred embodiment of the invention;

FIG. 4 is a flow chart of the preferred embodiment of the invention; and

FIG. 5 is another flow chart of the preferred embodiment of the invention.

### DETAILED DESCRIPTION OF PREFERRED EMBODIMENTS

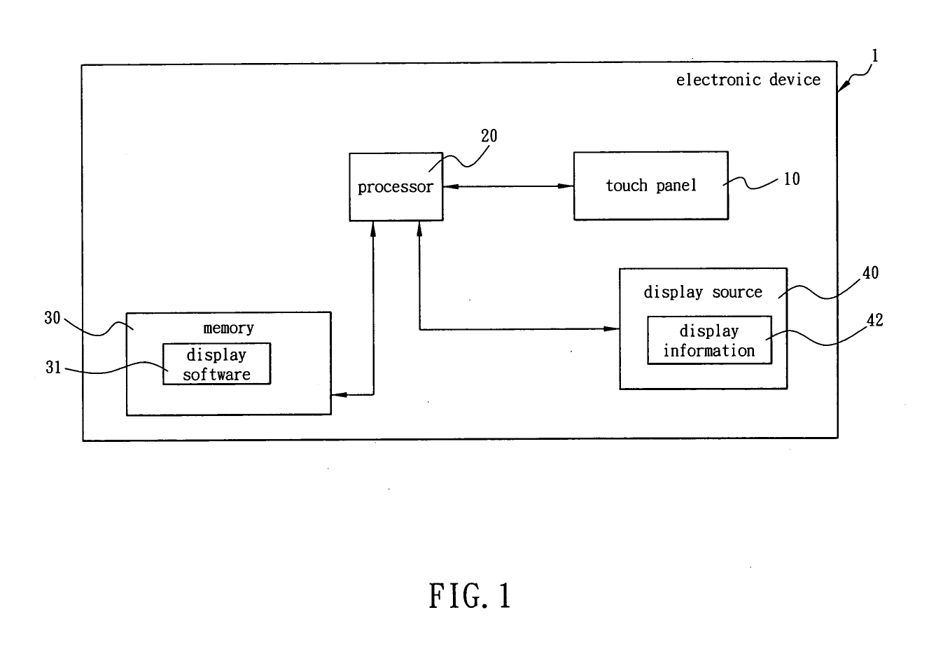

A method for zooming image has been disclosed in the invention. Referring to FIGS. 1, 2, and 3; the method is implemented to an electronic device 1 (such as cell phones, web browsers, and information guiding systems) having a touch panel 10. The electronic device 1 allows an image to be displayed on the touch panel 10; when the electronic device 1 detects that a first touch point 11′ and a second touch point 11″ generated on the touch panel 10 are pressed by a user simultaneously, and the first touch point 11′ remains stationary on the touch panel 10 while the second touch point 11″ operated by the user is moving on the touch panel 10, the image is zoomed in/out according to the direction where the second touch point 11″ is moving. Moreover, the image is zoomed in/out according to the proportion of the moving distance of the second touch point 11″ operated by the user on the touch panel 10. Accordingly, the user is able to zooming in or out the image shown on the touch panel 10 of the electronic device 1 via the operation of the first touch point 11′ and the second touch point 11″ generated on the touch panel 10.

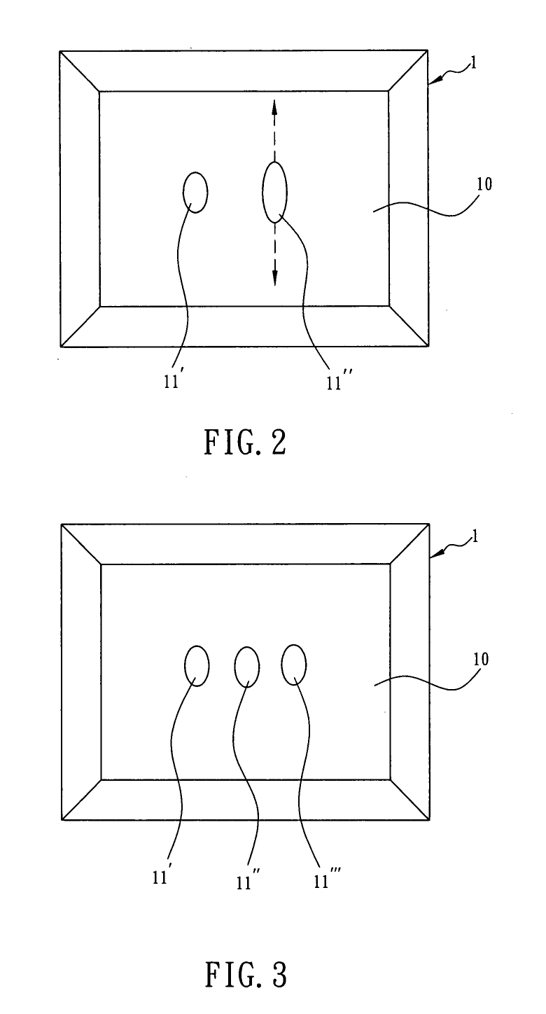

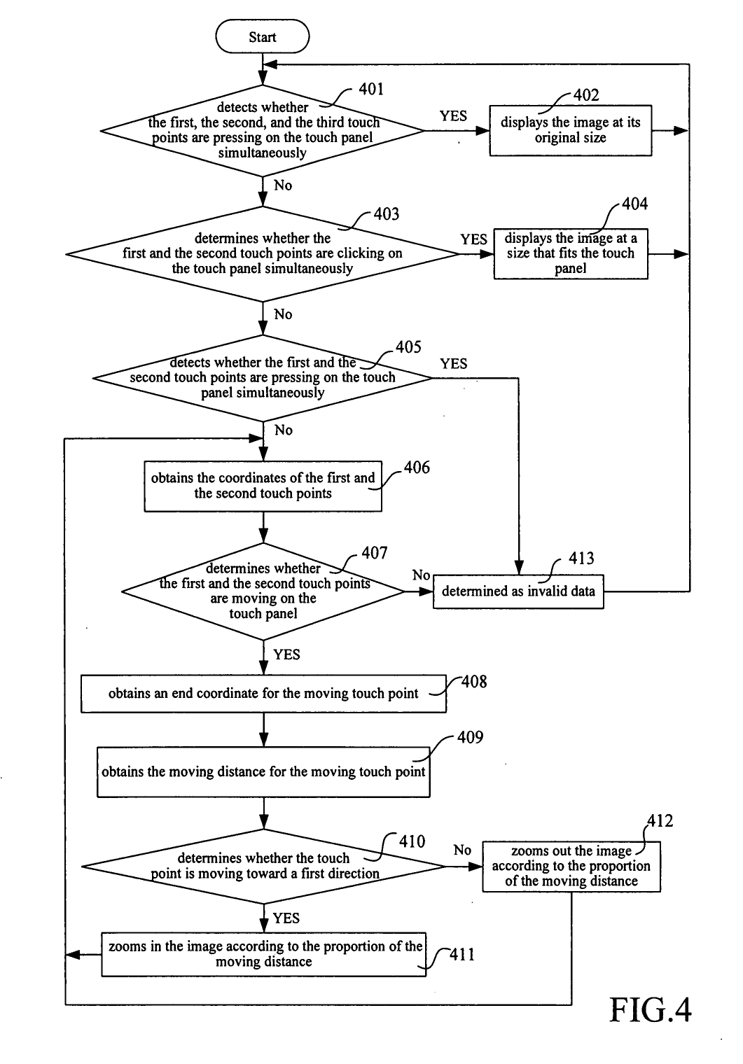

In a preferred embodiment of the invention, the electronic device 1 may be a mobile communication device (such as cell phones and PDA) that comprises a touch panel 10, a processor 20, a memory 30, and a display source 40 (for instance, storage devices or Internet portals); the memory 30 is built in with a display software 31, and the display source 40 provides at least one display information 42 (including video clips, images, or web pages). The touch panel 10 may detect at least one touch point (shown as a first touch point 11′, a second touch point 11″, and a third touch point 11′″ in FIGS. 2 and 3 of the invention) resulted from being touched by foreign objects (such as fingers of a user or touch pens); the touch or movement of the touch point is used to control a cursor or select a Graphic User Interface (GUI) on the touch panel 10. When the display software 31 reads a display information 42 and displays an image on the touch panel 10, as shown in FIG. 4, the processor 20 proceeds through the following steps:
(401) determining whether the touch panel 10 detects a first touch point 11′, a second touch point 11″ and a third touch point 11′″ being touched or pressed by a user simultaneously; if yes, proceeding with step (402), otherwise, going to step (403) instead;
(402) displaying the image with its original size on the touch panel 10 and returning to the step (401);
(403) determining whether the touch panel 10 detects the first touch point 11′ and the second touch point 11″ being clicked simultaneously (i.e. being pressed and then quickly moved away from the touch panel 10); if yes, proceeding with step (404), otherwise, going to step (405) instead;
(404) displaying the image on the touch panel 10 with a maximum resolution in compliance with the touch panel 10, and then returning to the step (401);
(405) determining whether the touch panel 10 detects the first touch point 11′ and the second touch point 11″ being pressed simultaneously; if yes, proceeding with step (413), otherwise, going to step (406) instead;
(406) obtaining the coordinates of the first touch point 11′ and the second touch point 11″ on the touch panel 10, and defining the aforesaid touch points as start coordinates, respectively;
(407) determining whether one of the first touch point 11′ and the second touch point 11″ is operated by the user to be moved on the touch panel 10; if yes, proceeding with step (408), otherwise, going to step (413) instead;
(408) obtaining a coordinate corresponding to the first touch point 11′ (or the second touch point 11″) being moved on the touch panel 10, and defining as an end coordinate;
(409) obtaining a moving distance for the first touch point 11′ (or the second touch point 11″) between the start coordinate and the end coordinate of the first touch point 11′ (or the second touch point 11″);
(410) comparing the start coordinate and the end coordinate, and then determining whether the first touch point 11′ (or the second touch point 11″) is moved toward a first direction; if yes, proceeding with step (411), otherwise, going to step (412) instead;
(411) after determining the first touch point 11′ (or the second touch point 11″) is moved toward the first direction, the electronic device 1 zooms in the image on the touch panel 10 according to the proportion of the moving distance, in which a central point of the touch panel 10 is used as a basis of zooming in, and then returning to the step (406);
(412) after determining the first touch point 11′ (or the second touch point 11″) is moved toward a second direction opposite to the first direction, the electronic device 1 zooms out the image on the touch panel 10 according to the proportion of the moving distance, in which the central point of the touch panel 10 is used as a basis of zooming out, and then returning to the step (406).
(413) determining that the first touch point 11′ (or the second touch point 11″) being pressed on the touch panel 10 is an invalid data and returning to the step (401).

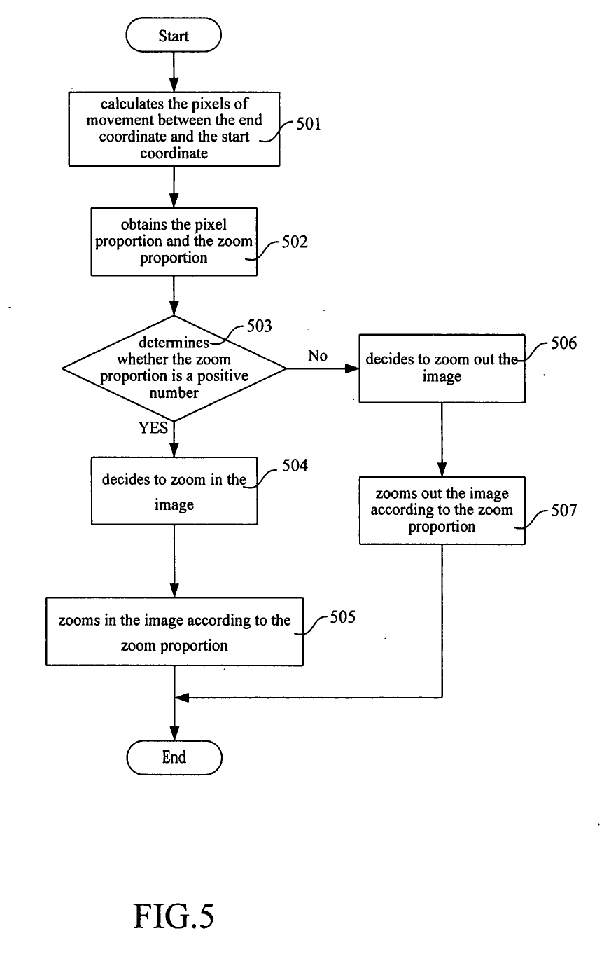

Referring to FIGS. 1 and 5, the moving distance mentioned in the preferred embodiment may be pixels of movement between the start coordinate and the end coordinate. When the processor 20 compares the start coordinate and the end coordinate, it determines whether to zoom in or zoom out the image in accordance with the following procedure:
(501) calculating the pixels of movement between the end coordinate and the start coordinate, which may be used as the moving distance for the aforesaid first touch point 11′ (or second touch point 11″);
(502) obtaining a pixel proportion from the pixels of movement, and then calculating a zoom in or out proportion from the moving distance (which is the pixel proportion) and moving direction;
(503) determining whether the zoom proportion is positive (+); if yes, proceeding with the step (504), otherwise, going to the step (506) instead;
(504) determining to zoom in the image;
(505) zooming in the image on the touch panel 10 according to the zoom proportion and completing this procedure.
(506) after determining the zoom proportion is negative (−), determining to zoom out the image;
(507) zooming out the image on the touch panel 10 according to the zoom proportion and completing this procedure.

In the step (502), the pixel proportion is preferably obtained by dividing the pixels of movement by the maximum vertical pixels of the touch panel 10.

In the steps (503) and (506), when the moving direction is up (either directly or obliquely), the resulted zoom proportion is positive (+); when the moving direction is down (either directly or obliquely), the resulted zoom proportion is negative (−).

Referring to FIGS. 1, 2, and 3 and using the preferred embodiment as an example; when a resolution of the touch panel 10 is 320*240, but a user intends to browse a web page with a resolution (1024*768) larger than that of the touch panel 10, the user needs to press and hold on a spot of the touch panel 10 with one finger, and use another finger to press on the touch panel 10 and move upwards, so that the web page is zoomed in on the touch panel 10 by the electronic device 1 according to a zoom in proportion, which is the proportion obtained by dividing the pixels of movement by the maximum vertical 320 pixels of resolution of the touch panel 10 in this case. Therefore, the larger the distance that has been moved upwards, the larger the proportion the web page is zoomed in. On the contrary, when the user touch on the touch panel 10 with one finger and use another finger to press on the touch panel 10 and move downwards, the web page is zoomed out proportionally on the touch panel 10 by the electronic device 1 according to the downward pixels of movement. To display the full view of the web page on the touch panel 10, the user only needs to use two fingers to touch on the touch panel 10 simultaneously, and the resolution of the web page will be adjusted by the electronic device 1 according to the resolution (320*240) of the touch panel 10. Furthermore, when the user presses on the touch panel 10 with three fingers simultaneously, the electronic device 1 allows the web page to be displayed with its original size (1024*768) on the touch panel 10.

A preferred embodiment of the invention is described as above, though the effects and structure of the invention are not limited to such scope. The electronic device 1 of the invention may be any electronic devices having touch panels that may display images or web pages, and are preferably handheld communication devices, including cell phones, PDA, multimedia players, or Global Positioning Systems (GPS). On the other hand, the non-mobile electronic device 1 may be implemented to information guiding systems, automatic teller machines (ATM), and public phones.

Although a particular embodiment of the invention has been described in details for purposes of illustration, it will be understood by one of ordinary skill in the art that numerous variations will be possible to the disclosed embodiments without going outside the scope of the invention as disclosed in the claims.

What is claimed is:

1. A method for zooming image being implemented to an electronic device having a touch panel, comprising:
displaying an image on the touch panel;
determining whether the touch panel detects a first touch point and a second touch point being pressed simultaneously;
determining whether the first touch point remains stationary on the touch panel and the second touch point is moved on the touch panel; and
determining to zoom in or out the image displayed on the touch panel according to the moving direction of the second touch point and zoom in or out the image in a proportion according to the moving distance of the second touch point.

2. The method of claim 1, wherein the step in which the electronic device determines whether the touch panel detects the first touch point and the second touch point simultaneously further comprises:
determining whether the first touch point and the second point on the touch panel are clicked simultaneously; and
if yes, displaying the image on the touch panel at a maximum resolution in compliance with the touch panel via the electronic device.

3. The method of claim 1, wherein the step in which the electronic device determines whether the touch panel detects the first touch point and the second touch point simultaneously further comprises:
determining whether the touch panel detects a third touch point simultaneously; and
if yes, displaying the image with an original size on the touch panel.

4. The method of claim 1, wherein when the second touch point is moved on the touch panel, the method proceeds through the following steps:
obtaining the coordinates of the first touch point and the second touch point on the touch panel, respectively, and then defining the first touch point as a first start coordinate, the second touch point as a second start coordinate, respectively;
obtaining a current coordinate for the second touch point on the touch panel, and defining as a second end coordinate thereof;
calculating a moving distance according to the second start coordinate and the second end coordinate;
determining whether the second touch point is moved toward a first direction or toward a second direction opposite to the first direction;
calculating a zoom proportion according to the moving distance and the direction of moving;
when the second touch point is moved toward the first direction, zooming in the image displayed on the touch panel according to the zoom proportion; and
when the second touch point is moved toward the second direction, zooming out the image displayed on the touch panel according to the zoom proportion.

5. The method of claim 4, wherein a central point of the touch panel is used as a basis for zooming in/out the image displayed on the touch panel.

6. The method of claim 4, wherein the moving distance is resulted from dividing the pixels of movement between the second start coordinate and the second end coordinate by the maximum vertical pixels of the touch panel.

7. The method of claim 4, wherein when the second touch point is moved toward the first direction, the zoom proportion is a positive number; and when the second touch point is moved toward the second direction, the zoom proportion is a negative number.

8. The method of claim 7, wherein the first direction is an upper direction, including directly or obliquely upper direction; and the second direction is a lower direction, including directly or obliquely lower direction.

9. A method for zooming image being implemented to an electronic device having a touch panel, comprising:
displaying an image on the touch panel;
determining whether the touch panel detects two touch points on the touch panel being pressed simultaneously; and
if yes, displaying the image on the touch panel at a maximum resolution in compliance with the touch panel.

10. A method for zooming image being implemented to an electronic device having a touch panel, comprising:
displaying an image on the touch panel;
determining whether the touch panel detects three touch points on the touch panel being pressed simultaneously; and
if yes, displaying the image with original size thereof on the touch panel.
